(19) United States
(12) Patent Application Publication
(10) Pub. No.: US 2021/0182849 A1
(43) Pub. Date: Jun. 17, 2021

(54) LIMITED SCOPE BLOCKCHAIN SYSTEM

(71) Applicant: Velo Holdings Limited, London (GB)

(72) Inventors: John Terrell DAVIES, London (GB); Andrew WEINSTEIN, Ross, CA (US); Justin HANDVILLE, London (GB)

(21) Appl. No.: 16/761,703

(22) PCT Filed: Nov. 6, 2018
(86) PCT No.: PCT/US18/59477

§ 371 Date: May 5, 2020

Related U.S. Application Data
(60) Provisional application No. 62/582,076, filed on Nov. 6, 2017.

(51) Int. Cl. G06Q 20/38; G06Q 20/40; H04L 9/32

(52) U.S. Cl. CPC G06Q 20/38215; G06Q 20/401; G06Q 2220/00; H04L 2209/38; H04L 2209/56; H04L 9/3263

(57) ABSTRACT

A limited scope blockchain system supports onboarding and payments via linked databases including an append-only database and a secondary database holding transaction requests that have not been applied to the blockchain.

### CROSS-REFERENCE TO RELATED APPLICATIONS

This application claims priority to the benefit of PCT application PCT/US/18/59477, filed Nov. 6, 2018, entitled “Limited Scope Blockchain System,” which claims priority to U.S. Provisional application 62/582,076, filed Nov. 11, 2017, entitled “Limited Scope Blockchain System,” the entire contents of which are incorporated herein by reference for all purposes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Blockchain technology may be applied to many transaction types. In some cases, such as an anonymous digital currency, a work function is added to slow down transactions to prevent double spending. However, transactions between known and auditable entities may be less concerned about double spending and have a greater interest on scalability.

### SUMMARY

A limited scope blockchain system implements a single blockchain agent supporting only entity on-boarding transactions and payment transactions.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 illustrates a process flow for onboarding;

FIG. 2 illustrates a flow for authentication with a blockchain agent;

FIG. 3 illustrates a payment transaction flow;

FIG. 4 illustrates a transaction status flow; and

FIG. 5 illustrates a flow for querying the ledger.

### DETAILED DESCRIPTION

A system for demonstrating blockchain ledger concepts may use production level components for implementation of the demo system. The demonstration system includes on-boarding and payment transaction support.

### Ledger Scope

The purpose of the demo ledger is to demonstrate the key concepts of the ledger in conjunction with the Velo demo. This is a scaled-down ledger, but it is still designed and implemented as a production-deployable component.

There are several major differences between the demo ledger and the MVP ledger. The first is that there is only one blockchain agent operating on the demo ledger. This allows us to demonstrate the append-only nature of the ledger and local recovery without having to worry about network partitioning and voting. Next, the variety of transactions supported natively by the ledger is reduced to entity onboarding transactions and payment transactions. Blockchain agent onboarding is performed just once as part of the root block of the ledger, and all participating entities need only read the root block to retrieve the blockchain agent record. Finally, the smart contract virtual machine has been removed from scope, meaning that the only contracts that can be embedded within transactions are hard-coded contract IDs that are provided as part of the ledger library. These scope changes allow us to build a functioning ledger in weeks instead of months, which means that we will be able to demonstrate a functioning ledger as part of the larger demo. This ledger will be very similar to the MVP ledger in operation, and we will be able to backfill more complete functionality without directly impacting the interface between the demo and the ledger.

All of this being said, there are a few future features and idiosyncrasies that must be taken into account regarding a ledger interface. The scaled-down ledger may be designed to have the same interface as a production ledger, but it will not behave in a manner that is entirely compatible with a production ledger. For instance, from a CAP Theorem perspective, the production ledger is an AP system. It has both Availability and Partition-tolerance. Because of this, it does not have Consistency. Two potential production exceptions that may not present themselves in a demo are transaction rejections and contract rejections. The former occurs when some property of the transaction—such as the transaction ID—is invalid when reconciled with the ledger. The latter occurs when attempting to apply the transaction to the ledger would invalidate the contract. As an example of the former, imagine that there is a collision of UUIDs between the local transaction and the global ledger. When the blockchain agent attempts to reconcile records between its local ledger or a partitioned ledger and the network ledger or another ledger partition, it may lose the election, and it may have to resubmit blocks against a slightly different ledger. If a UUID collision occurs, then a transaction exception will occur. This collision could happen seconds or hours after a transaction is submitted. Likewise, if a reconciliation event causes a contract to become invalidated, then a contract exception could occur. In both of these cases, the original submitter would need to periodically check the ledger for any rejected transactions. Corrective action may be required to resubmit these transactions. Obviously, in a happy-path demo, such exceptional conditions would not occur, but as the ledger is back-filled with production functionality, it is possible that these exceptional conditions will occur.

The point of the demo scoping exercise is to ensure that, as far as we know, the interface between the demo ledger and the demo application is aware of exceptions that may occur in the future, so that we do not have to make major contract changes between these two components. So, while the demo application is free to cache information from the ledger, it must be designed to treat the ledger as the source of truth, and it must understand that this source of truth may have some slight fluctuations for newer transactions in the future due to network partitions. For now, it may be enough to place the entire demo into an error state if this should occur, and create a demo ledger that only supports a single blockchain agent so that the issue does not occur in practice. Then, later on, when we need to test partitioning, the demo application will fail gracefully.

### Low-Level Components

The ledger library is a cross-platform library that manages the reconciliation of transactions within the ledger. This library is one of two major production deliverables for the Velo Ledger. The second major production deliverable is the distributed blockchain agent, which is a Java service that adds network capability to this cross-platform library.

Obviously, for the sake of the demo, we will not be writing the complete cross-platform library nor the distributed blockchain agent. We will, however, be delivering features that will be incorporated into both, modulo some refactoring. As such, it makes sense to build prototype code that mirrors, as closely as possible, the architecture of the final deliverables so that refactoring can be production refinement instead of throw-away rewriting.

The cross-platform library will be written in C. This ensures that we can pivot quickly on porting major functions to other platforms, and this gives us the ability to build proofs of correctness after MVP, using one of several potential proof checkers that work with C.

The main features that we need for the demo ledger are certificate building/parsing support and support for the cryptography necessary for our demo. In order to deliver this support, we need a simple platform library for C that implements an allocator interface and an abstract factory pattern. We will begin by describing these components and building upon them from the bottom-up.

### Platform Library

The platform library is an abstraction layer between the certificate and cryptography code written in C and the underlying platform (e.g. Java, .NET, Swift, Android, Linux). This allows us to encapsulate the best way to manage certain operations, such as memory allocation or dependency injection, so that we can select the best options for a given platform. For instance, certain versions of Android have a terrible cryptographic pseudo-random number generator. Our crypto library, on this platform, will select an internal CPRNG that meets our standards. However, in order to do this, we need some heavy lifting in the platform library to manage DI.

Three things will be required for the demo: an allocator library, an abstract factory pattern, and a simple array list data structure.

### Crypto Library

The crypto Library provides an interface for selecting the correct cryptographic primitives for a given task and using these primitives to perform cryptographic operations in the block chain. The seven main operations we need are cryptographi-cally random number generation, key generation, cryptographic hashing, digital signing, digital signature verification, key agreement, and block/stream cipher encryption.

The Crypto Library builds on the Platform Library by providing support for both interfaces and factories. This allows us to select different implementations of the primitives based on the platform so that we can select the most appropriate implementation for a given platform. For the sake of the demo, the reference implementations of each of these primitives will be sufficient, but the interfaces can be defined now.

### Certificate Library

The Certificate Library provides two important interfaces for certificates. The Certificate Builder interface allows a user to build a certificate of the given transaction type. It allows the user to append fields of a given type to the certificate and provides a method for signing the certificate with the user's identity and key (provided as a private key certificate). The builder interface also verifies the contract for a given transaction type to ensure that this certificate is valid. However, for the demo, this mechanism will not be implemented at first.

The second interface is the certificate parser. The parser verifies the signature of a certificate, then verifies that the certificate is contractually valid (not implemented for demo). The user can query a valid certificate for fields matching a given field type.

In the production version of the certificate parser and builder, there is support for a mapping table that maps field type UUIDs to 16-bit shorthand values. In the demo, this mapping will be hard-coded by certificate type. The interfaces for both demo and production will be similar, in that the user code will append or search for fields by the long-hand UUID.

### Higher-Level Components

Two higher-level components are required for the demo. These are the Ledger Library, which is the basic interface by which both the blockchain agent and clients communicate with each other, and the blockchain agent itself.

### Ledger Library

The ledger library will be implemented as a Java interface for now. This library will encapsulate the functionality required to communicate with the ledger through an appropriate transport. Depending upon the architecture of the demo application, this can either be synchronous or asynchronous communication.

Feature-wise, the ledger library needs to provide an interface that allows a user to authenticate with the blockchain agent, request a transaction ID, submit a transaction to the blockchain agent as a signed certificate with this requested transaction ID, and get back a success or failure response. After this point, the transaction is “owned” by the blockchain agent. Any user can query the blockchain agent for the status of a transaction by transaction ID. The agent will respond with what it knows, up to and including the block to which the transaction has been assigned.

Users can also query the blockchain agent for raw blocks. This mechanism can be used to build a cache of transaction information from the ledger, which can be queried ahead of searching the ledger itself. Outside of the scope of this demo delivery is the ability for users to open a websocket connection with the blockchain agent to receive notifications of changes to the blockchain.

In order for a user to authenticate with the blockchain agent, the user's identity must be placed in the ledger through an onboarding transaction. Out of the scope for the demo is the revocation transaction, or “offboarding” transaction.

### Blockchain Agent

The demo blockchain agent is a scaled down version of the production agent. This agent does not work with other agents, so much of the complexity of managing network partitions can be sidestepped.

The blockchain agent maintains two databases. The primary database is the ledger itself. This is an append-only data structure that acts as a transaction log. On startup, the blockchain agent reads the ledger and reconciles it with the secondary database, which contains the transaction cache.

The transaction cache is a series of indices that make lookups by transaction ID, user ID, or any other relevant entity ID within the ledger easier. The transaction cache also tracks transaction IDs issued to users for use in transactions.

Other features of the secondary database include transaction requests that have not yet been applied to the blockchain, and foreign keys on each table that relate to block IDs. If a block or series of blocks should be invalidated after a network partition ends, then the local blockchain agent needs to be able to roll back data in the secondary database to match the ledger. This may mean reverting transaction requests that were resolved locally but were invalidated by the new ledger. These requests must be revalidated and re-applied. While network partition recovery is out of scope for the demo, it makes sense to implement the minimal data in the secondary database that can support future recovery, namely, the block to which a given transaction belongs.

Since smart contracts are out of scope, contract rules for transactions are hard-coded in C++, behind a C facade. These contracts checked by both the client and agent. For the demo, the 3 contracts supported are: Entity Lifecycle (onboarding only for now), Velo Demo Payment Lifecycle, and Block Agent Lifecycle (root onboarding only for now).

### Payment Flows

This section describes the payment flows required as part of Velo demo payments. There are 5 flows required to register payments to the ledger and query the ledger for status. In these 5 flows, we also include a flow for clients to build their own secondary databases by reading raw blocks from the ledger. The flows in this chapter are: Entity Onboarding, User Authentication, Payment Transaction Submission, Transaction Status Querying, and Basic Ledger Reconciliation (Caching).

### Understanding Transactions and the Ledger

The ledger is an append-only database that manages transactions. Everything within the ledger is a transaction. A transaction changes the state of an artifact within a system. The first transaction involving an artifact creates this artifact and sets it into one of the initial states supported by that artifact's contract. Subsequent transactions can change the state of an artifact to a different state that is allowed by its contract. Most artifacts eventually reach a quiescent state at which point no further state changes are accepted.

A contract is a description of the possible states in which an artifact can exist and the rules by which an artifact is allowed to move from one state to the next. In a way, artifacts represent state machines, and the contract is the state transition diagram for an artifact.

Entities, described in the next section, are a special type of artifact which have the ability to evolve other artifacts, including possibly themselves.

### Entity Onboarding

Anything within the Velo ledger that is capable of creating or evolving a transaction is an entity. Onboarding itself is the beginning of a transaction that participates in the Entity Lifecycle. In the onboarding transaction, an entity is created in the system as a special artifact, and its public key is embedded into the ledger. Only an entity with the capability of onboarding artifacts is allowed to submit this transaction to the ledger.

For the purpose of the demo, we will hard-code an onboarding entity into the root certificate of the ledger. This onboarding entity's private key will be used by the demo application to onboard new users into the ledger, which will allow these users to authenticate with the blockchain agent and submit payment transactions to the ledger. Note that the onboarding entity can only be used to onboard users; user entities must be used to create payment transactions.

The following flow shows onboarding. It does not show authentication, which must be performed by the onboarding entity prior to submitting a transaction request for an onboarding transaction. Authentication will be covered in the next section. Entity authentication works the same regardless of whether this is for a user on an onboarding entity.

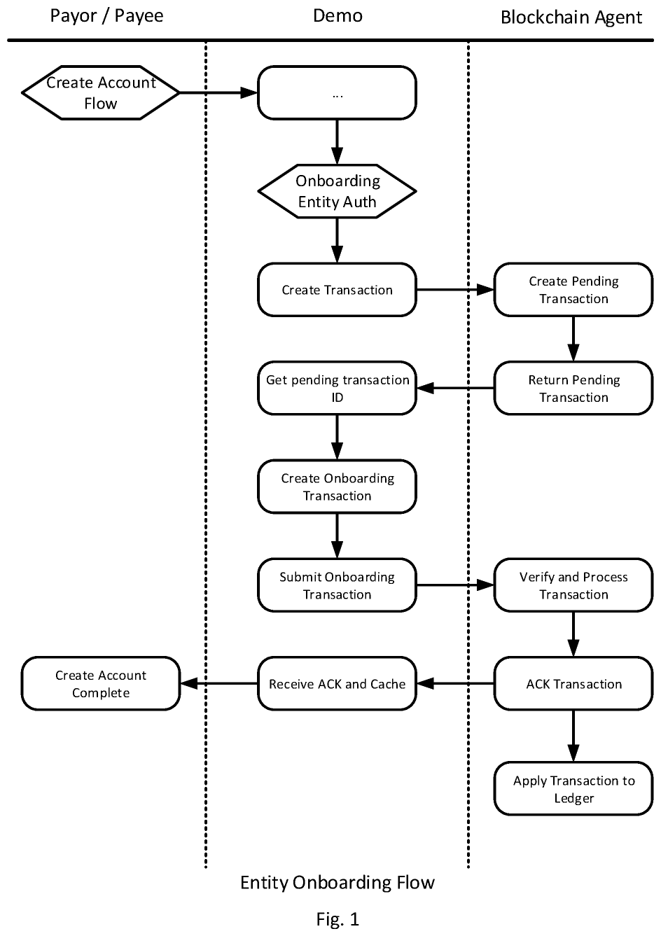

FIG. 1 shows the onboarding flow. During the last step of the existing flow to create an account, the demo app authenticates as the onboarding entity. It then posts a create transaction request to create a transaction ID for the new entity. After receiving a transaction ID as a response from the blockchain agent, the demo app creates an onboarding transaction and submits this to the blockchain agent. The blockchain agent acknowledges this transaction and adds it to its pending transaction queue. The demo app receive the acknowledgment and caches this transaction as a pending transaction, with a future action to check the transaction status and update the cache accordingly. The user is then given back control in the onboarding flow in the web app. In the background, the blockchain agent applies this transaction to the next block in the ledger along with any other pending transactions.

### User Authentication

This section is titled “User Authentication”, although, this process applies to all entities.

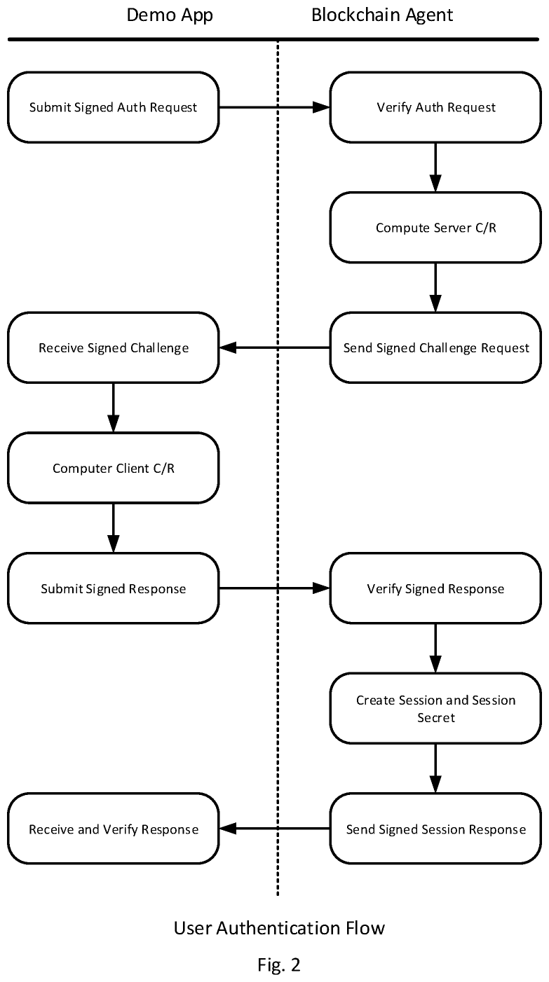

Authentication with a blockchain agent is performed using a basic signed challenge/response. In this process, two entities can mutually authenticate each other. FIG. 2 shows the flow for this process. The user posts an authentication request to the blockchain agent. This is a signed certificate that contains a client nonce value. This nonce value is encrypted using the shared secret between the blockchain agent and the user. The blockchain agent verifies the signature of this authentication request and responds with a signed challenge certificate. This certificate contains both the encrypted client nonce and an encrypted server nonce, encrypted using the same shared secret between the blockchain agent and the user. To verify the server's identity, this certificate also contains the server response, which is HMAC(shared_secret, sc+cc). The client responds with a response certificate, which contains the client response, which is HMAC(shared_secret, cc+sc). In order to compute the HMACs, both the client and the server must possess the shared secret, which is computed using the respective encryption keypairs. In order to sign each certificate, both the client and server must verify that they have possession of their respective private signing keys. The blockchain agent responds with a certificate containing the session UUID, which must be set in the header of subsequent requests, and an encrypted session key, which must be used to HMAC subsequent requests. The blockchain agent, in turn, will HMAC all responses and place these in a header, which the client can use to verify that communication between the client and the blockchain agent is secure. Additionally, the body of each subsequent request and response will be encrypted using this session key. The specifics of this process will be documented in the Velo Ledger Protocol Document.

### Payment Transaction Submission

The flow for payment transactions looks identical to the flow for entity onboarding. This is by design: all transactions in the Velo ledger will look the exact same. The content and context may differ, as may the contracts that must be verified, but a transaction is a transaction. Whether a payment is being created or the payment is being evolved to a new state, this is the flow that is followed. The details in the submitted certificate may differ, however. Transaction creation certificates and transaction state change certificates require different information. Specifically, when a new artifact is created, the artifact type and contract must be specified. When an artifact is evolved through a subsequent transaction, only the artifact identifier and information relevant to the new state is required.

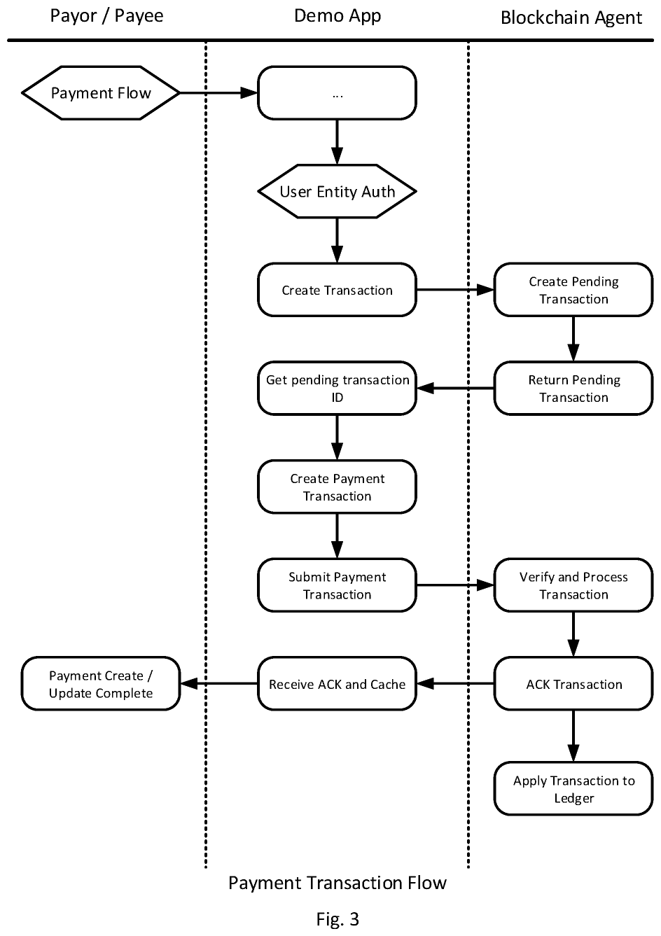

FIG. 3 shows the payment transaction flow.

### Transaction Status Querying

Periodically, it may be necessary for the demo app to query the status of a transaction. Ultimately, this process should be man-aged by subscribing to a view of the ledger as it evolves, but for the sake of the demo, we can implement a transaction-specific view of data in the ledger. The blockchain agent maintains a secondary database that indexes all transactions relating to spe-cific artifacts, as well as the current state of a given transaction for that artifact. The artifact-specific flow and the transaction-specific flow are both the exact same. The only difference is the location of the API call. In RESTful terms, one will point at /artifacts/<artifact-uuid>/statusand the other will point at /transactions/<transaction-uuid>/status.

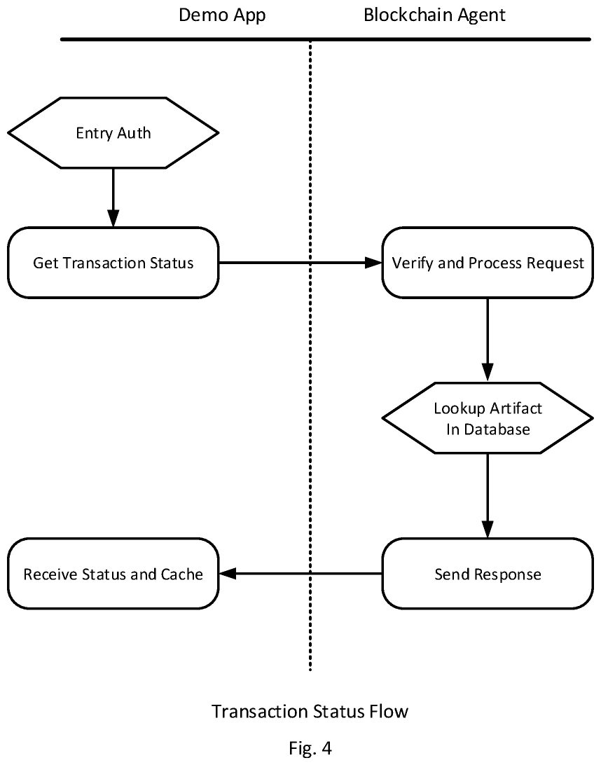

FIG. 4 shows the flow. Transactions are visible to all users, but the details may be encrypted. As such, the entity used for authentication will vary based on the need of the demo app.

### Basic Ledger Reconciliation

The ledger reconciliation process flow works the same way as the transaction/artifact status query. The main difference is that ledger blocks contain multiple transactions as well as a reference to the previous block in the chain. The query location for a ledger block is /ledger/<block-uuid>. Two special locations, /ledger/rootand/ledger/latest, point to the root block and the latest block in the ledger (according to the blockchain agent), respectively. Additionally, the /ledger/latest query will return an ETag that can be verified to reduce the overhead of this call if nothing has changed.

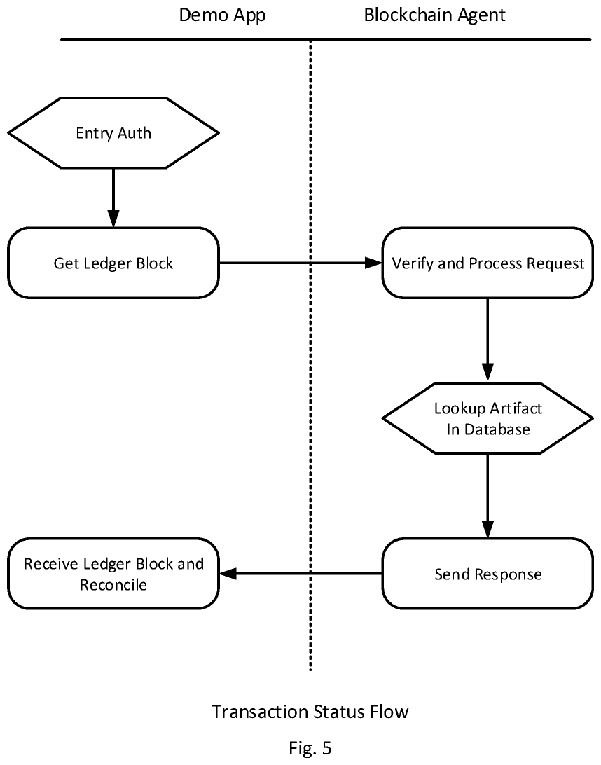

FIG. 5 shows the flow for querying the ledger. Note that the reconciliation process may expose orphan blocks. These should be culled from the demo app cache.

We claim:

1. A blockchain system comprising:
a ledger library including a user interface supporting user authentication with a blockchain agent, requesting a transaction identifier, submitting a signed certificate representing a transaction request, and receiving a response indicating one of success or failure; and
a blockchain agent including a first database limited to append-only transactions and a second database supporting a transaction log, wherein the blockchain system supports contracts for entity onboarding, payment lifecycle, and block agent lifecycle.
